(19) United States
(12) Patent Application Publication
(10) Pub. No.: US 2018/0001712 A1
(43) Pub. Date: Jan. 4, 2018

(54) PNEUMATIC TIRE

(71) Applicant: Toyo Tire & Rubber Co., Ltd., Osaka (JP)

(72) Inventor: Tsuyoshi Fujioka, Osaka-shi (JP)

(73) Assignee: Toyo Tire & Rubber Co., Ltd., Osaka (JP)

(21) Appl. No.: 15/617,114

(22) Filed: Jun. 8, 2017

(30) Foreign Application Priority Data
Jun. 30, 2016 (JP) 2016-130572

(51) Int. Cl. B60C 11/12; B60C 11/03; B60C 11/13

(52) U.S. Cl. CPC B60C 11/1236; B60C 11/1353; B60C 11/1204; B60C 11/0309; B60C 2011/1213; B60C 2011/1361

(57) ABSTRACT

In a shoulder block row in which a plurality of shoulder blocks are disposed in a tire circumferential direction, a lateral groove between adjacent shoulder blocks in the tire circumferential direction has a first shallow groove portion that is positioned on a side close to a main groove and has a depth shallower than that of the main groove, a third shallow groove portion that is positioned on a side close to a tire ground contact end and has a depth shallower than that of the main groove, and a second shallow groove portion that is positioned between the first shallow groove portion and the third shallow groove portion, and has a depth shallower than those of the first shallow groove portion and the third shallow groove portion.

### CROSS-REFERENCE TO RELATED APPLICATIONS

This application is based upon and claims the benefit of priority from the prior Japanese Patent Application No. 2016-130572, filed on Jun. 30, 2016; the entire contents of which are incorporated herein by reference.

### BACKGROUND

### 1. Field of the Invention

This embodiment relates to a pneumatic tire.

### 2. Related Art

In pneumatic tires, a so-called block pattern tire, in which a block row formed by a main groove extending in a tire circumferential direction and a lateral groove intersecting the main groove is provided in a tread portion, is known (see JP-A-H5-085110, JP-A-2008-222090, and JP-A-H11-059135).

In such a tire having a block pattern, it has been proposed to provide a bridge in the lateral groove between adjacent blocks in a tire circumferential direction to connect the front and rear blocks in order to increase the rigidity of the block and to improve the uneven wear resistance property (see US2012/080130A1). However, if the bridge is provided, since the lateral groove becomes shallow at that portion, a groove volume becomes smaller correspondingly, which causes a decrease in an earth discharging property and a traction property.

### SUMMARY

An object of this embodiment is to improve the uneven wear resistance property while suppressing a decrease in the earth discharging property and the traction property.

The pneumatic tire according to the embodiment is provided with a shoulder block row at an end portion of a tread portion in a tire width direction. The shoulder block row is configured such that a plurality of shoulder blocks partitioned by lateral grooves between a main groove extending in a tire circumferential direction and a tire ground contact end are arranged in the tire circumferential direction. In the pneumatic tire, the lateral groove between adjacent shoulder blocks in the tire circumferential direction has a first shallow groove portion that is positioned on a side close to the main groove and has a depth shallower than that of the main groove, a third shallow groove portion that is positioned on a side close to the tire ground contact end and has a depth shallower than that of the main groove, and a second shallow groove portion that is positioned between the first shallow groove portion and the third shallow groove portion, and has a depth shallower than those of the first shallow groove portion and the third shallow groove portion.

### BRIEF DESCRIPTION OF THE DRAWINGS

FIG. 1 is a perspective view of a pneumatic tire according to an embodiment.

FIG. 2 is partially enlarged perspective view of a tread portion of the same embodiment.

FIG. 3 is a developed view illustrating a tread pattern of the same embodiment.

FIG. 4 is an enlarged plan view of a main portion of the tread portion of the same embodiment.

FIG. 5 is a sectional view that is taken along line V-V of FIG. 4.

FIG. 6 is a sectional view that is taken along line VI-VI of FIG. 4.

FIG. 7 is a sectional view that is taken along line VII-VII of FIG. 4.

### DETAILED DESCRIPTION

Hereinafter, embodiments will be described with reference to the drawings.

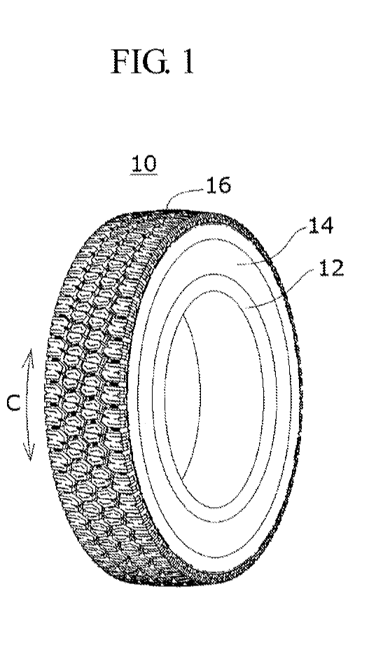

As illustrated in FIG. 1, a pneumatic tire 10 according to an embodiment includes a pair of right and left bead portions 12 and side wall portions 14, and a tread portion 16 that is provided between both side wall portions so as to connect radially outer end portions of the right and left side wall portions 14, and a general tire structure can be adopted for other than a tread pattern.

As illustrated in FIGS. 1 to 3, a plurality of block rows 22 formed by a plurality of main grooves 18 extending in a tire circumferential direction C and a plurality of lateral grooves 20 intersecting the main grooves 18 are provided on a tread rubber surface of the tread portion 16 in a tire width direction W.

In the example, three main grooves 18 are formed at intervals in the tire width direction W. A center main groove 18A positioned on a tire equator CL and a pair of shoulder main grooves 18B and 18B disposed on both sides are provided. Each of the three main grooves 18 is a zigzag groove extending in the tire circumferential direction C while being bent. Moreover, the main groove 18 is a circumferential groove having a groove width (opening width) of generally 5 mm or more.

A plurality of land portions partitioned by the main grooves 18 are formed in the tread portion 16. The plurality of lateral grooves 20 are provided at intervals in the tire circumferential direction C. Therefore, land portions are formed as the block row 22 in which a plurality of blocks are arranged in the tire circumferential direction C. More specifically, a pair of right and left center land portions sandwiched by the center main groove 18A and the shoulder main grooves 18B is formed as center block rows 22A formed by disposing a plurality of center blocks 24 in the tire circumferential direction C by being partitioned by lateral grooves 20A. The center block row 22A is a block row positioned at a center portion in the tire width direction W in the tread portion 16. In addition, a pair of right and left shoulder land portions sandwiched by the shoulder main grooves 18B and tire ground contact ends E is formed as shoulder block rows 22B formed by disposing a plurality of shoulder blocks 26 in the tire circumferential direction C by being partitioned by the lateral grooves 20B. The shoulder block rows 22B are block rows positioned at both end portions in the tire width direction in the tread portion 16.

The lateral grooves 20A and 20B are grooves extending in a direction intersecting main grooves 18A and 18B, and crossing each land portion. The lateral grooves 20A and 20B may not necessarily be parallel to the tire width direction W as long as they are grooves extending in the tire width direction W. In the example, the lateral grooves 20A and 20B are grooves extending in the tire width direction W while being inclined.

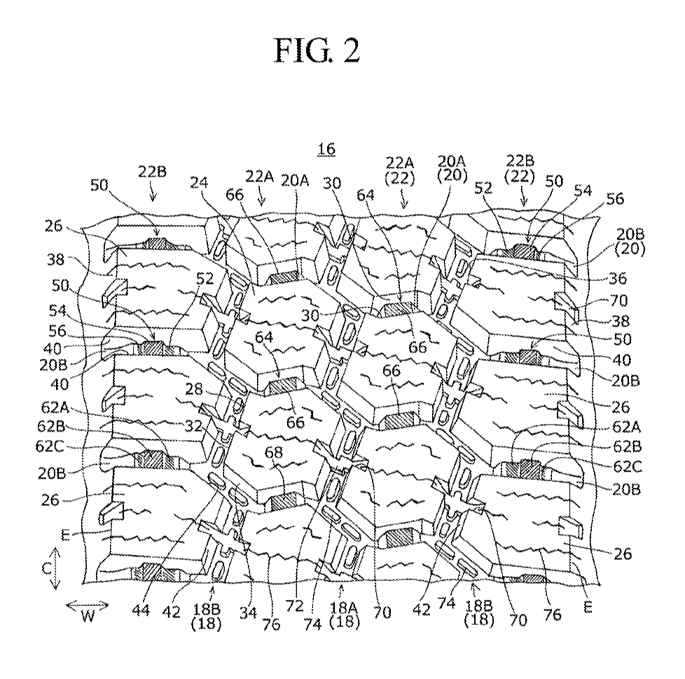

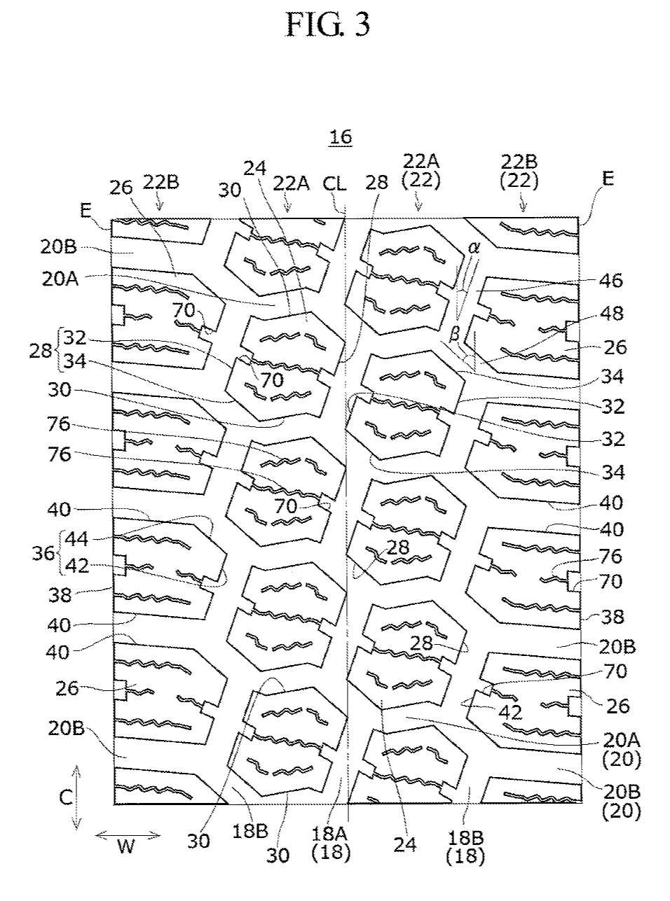

As illustrated in FIGS. 2 and 3, the center block 24 includes a pair of right and left longitudinal side surface portions 28 and 28 facing the right and left main grooves 18A and 18B (that is, configuring a part of the groove wall surface of the main groove by being in contact with the main groove), and a pair of front and rear lateral side surface portions 30 and 30 facing the front and rear lateral grooves 20A and 20A. In the example, the center block 24 has a substantially hexagonal shape (convex hexagonal shape) in a plan view. More specifically, the pair of longitudinal side surface portions 28 and 28 is formed of a pair of first longitudinal side surface portions 32 and 32 inclined with respect to the tire circumferential direction C and parallel to each other, and a pair of second longitudinal side surface portions 34 and 34 having a shorter length than that of the first longitudinal side surface portions 32, inclined greater with respect to the tire circumferential direction C than the first longitudinal side surface portions 32, and parallel to each other. The second longitudinal side surface portion 34 is formed so as to intersect the first longitudinal side surface portion 32 at an obtuse angle. The pair of lateral side surface portions 30 and 30 is side surface portions inclined with respect to the tire width direction W and parallel to each other.

The shoulder block 26 includes a longitudinal side surface portion 36 facing the shoulder main groove 18B, a longitudinal side surface portion 38 facing the tire ground contact end E (that is, configuring a part of a ground contact end wall surface), and a pair of front and rear lateral side surface portions 40 and 40 facing the front and rear lateral grooves 20B and 20B. In the example, the shoulder block 26 has a substantially pentagonal shape (convex pentagonal shape) in a plan view. More specifically, the longitudinal side surface portion 36 is formed of a third longitudinal side surface portion 42 which is inclined with respect to the tire circumferential direction C, and a fourth longitudinal side surface portion 44 which is shorter than the third longitudinal side surface portion 42 in length and is inclined greater with respect to the tire circumferential direction C than the third longitudinal side surface portion 42. The fourth longitudinal side surface portion 44 is formed so as to intersect the third longitudinal side surface portion 42 at an obtuse angle. The pair of lateral side surface portions 40 and 40 is side surface portions inclined with respect to the tire width direction W and parallel to each other.

Because of the shapes of the center block 24 and the shoulder block 26 described above, the main groove 18 and the lateral groove 20 are provided as follows. As illustrated in FIG. 3, the main groove 18 has a first groove portion 46 that is inclined to one side at the angle α with respect to the tire circumferential direction C and a second groove portion 48 that is inclined to another side at an angle β with respect to the tire circumferential direction C, which are alternately repeated via an obtuse angle-shaped bent portion in the tire circumferential direction C thereby forming a zigzag shape. The second groove portion 48 is shorter than the first groove portion 46 and the inclined angle β with respect to the tire circumferential direction C is set greater than the inclined angle α of the first groove portion 46. Moreover, between adjacent main grooves 18A and 18B, top portions of the bent portions are disposed to face each other, the top portions are connected by the lateral groove 20A, and thereby the center block rows 22A are formed. In addition, the lateral grooves 20B are provided outward of the shoulder main groove 181B in the tire width direction from the top portion of each bent portion to the tire ground contact end E and thereby the shoulder block rows 22B are formed.

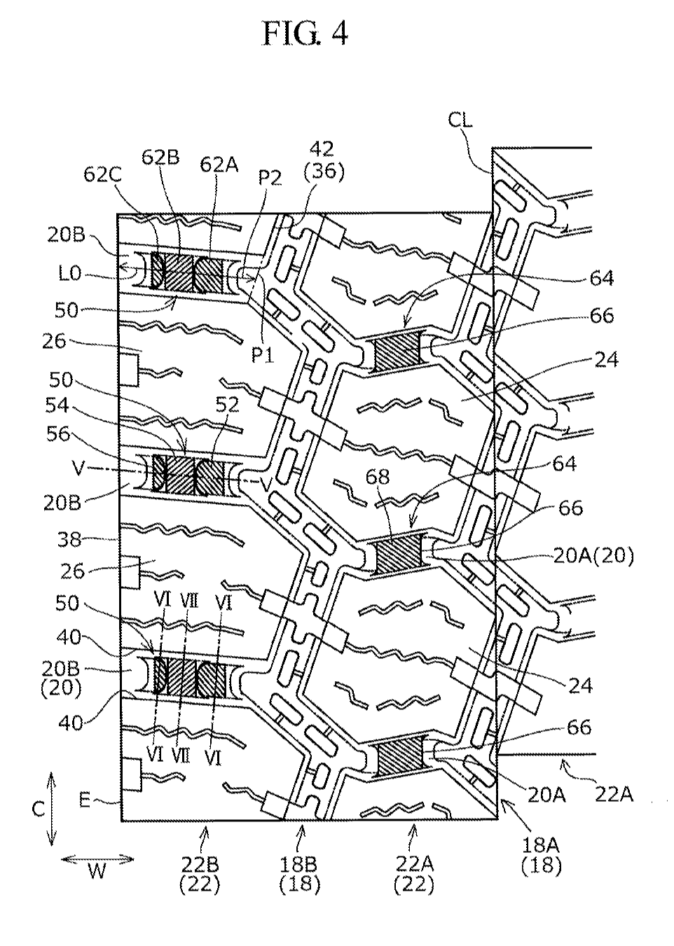

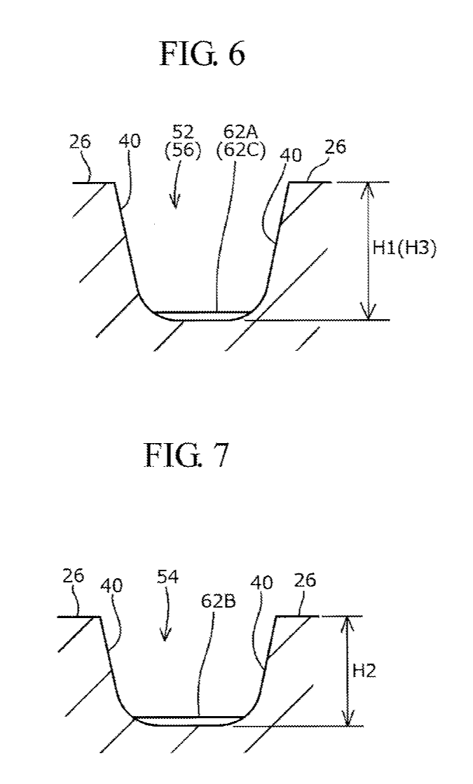

As illustrated in FIGS. 2 and 4, each lateral groove 20B between the adjacent shoulder blocks 26 and 26 in the tire circumferential direction C is provided with a bridge 50 connecting the lateral side surface portions 40 and 40 facing each other. Therefore, in the lateral groove 20B, a shallow groove portion shallower than the shoulder main groove 18B in depth is formed at a position at which the bridge 50 is provided in an entire groove width (see FIGS. 6 and 7). More specifically, in the lateral groove 20B, a first shallow groove portion 52 which is positioned on a side close to the shoulder main groove 18B, a third shallow groove portion 56 which is positioned on a side close to the tire ground contact end E, and a second shallow groove portion 54 which is positioned between the first shallow groove portion 52 and the third shallow groove portion 56 are provided, and a groove depth is formed in a plurality of steps in the length direction of the lateral groove 20B.

As illustrated in FIGS. 4 to 6, the first shallow groove portion 52 is a lateral groove portion having a depth H1 shallower than a depth of the shoulder main groove 18B, and is formed by raising a groove bottom from a groove bottom base surface 58 of the lateral groove 20B having the same height as the groove bottom of the shoulder main groove 18B. More specifically, the first shallow groove portion 52 is formed from the groove bottom base surface 58 via an inclined surface 57. The first shallow groove portion 52 is a shallow groove portion adjacent to the shoulder main groove 18B, that is, is a shallow groove portion on the shoulder main groove 18B side among the shallow groove portions formed by the bridge 50.

The third shallow groove portion 56 is a lateral groove portion having a depth H3 shallower than the depth of the shoulder main groove 18B. In the example, the depth H3 of the third shallow groove portion 56 is set to the same depth as the depth H1 of the first shallow groove portion 52, but may be set to a different depth. The third shallow groove portion 56 is a shallow groove portion adjacent to the tire ground contact end E, that is, is a shallow groove portion on the tire ground contact end E side among the shallow groove portions formed by the bridge 50. An inclined surface 59, which is inclined so that a groove depth becomes gradually deeper, is provided on an outer side of the third shallow groove portion 56 in the tire width direction and the lateral groove 20B opens to the ground contact end wall surface via the inclined surface 59.

As illustrated in FIGS. 4, 5 and 7, the second shallow groove portion 54 is a lateral groove portion having the depth H2 shallower than those of the first shallow groove portion 52 and the third shallow groove portion 56, that is, H2<H1 and H2<H3. The second shallow groove portion 54 is the shallow groove portion sandwiched between the first shallow groove portion 52 and the third shallow groove portion 56, and is formed by raising the groove bottom to be stepwise with respect to the first shallow groove portion 52 and the third shallow groove portion 56.

Here, the depths H1, H2, and H3 of respective the shallow groove portions 52, 54, and 56 are, as illustrated in FIGS. 6 and 7, heights from the groove bottom to the ground contact surface excluding serrations which are described below.

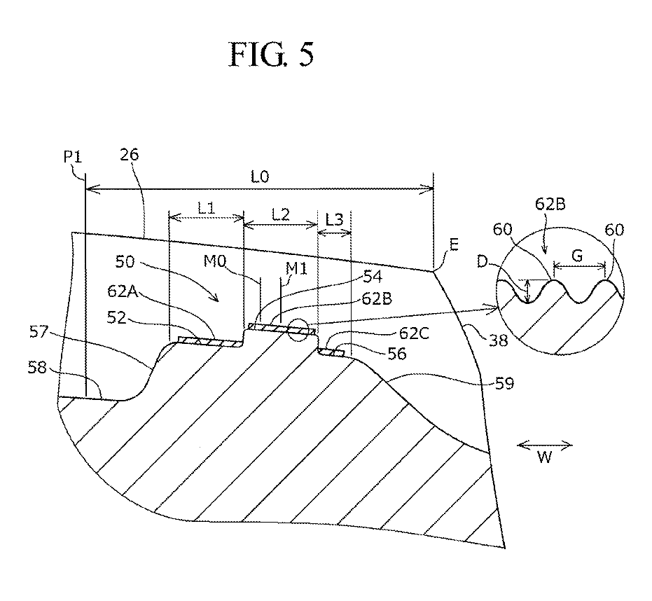

As illustrated in FIG. 5, a center position M1 of the second shallow groove portion 54 in the tire width direction W is positioned closer to the tire ground contact end E side than a center position M0 of the lateral groove 20B in the tire width direction W. That is, the second shallow groove portion 54 is offset toward the tire ground contact end E side. Here, the center position M0 of the lateral groove 20B is a position corresponding to a center point of a length L0 of the lateral groove 20B extending in the tire width direction W. As illustrated in FIG. 4, an extension line P1 formed by extending the ridgeline of the third longitudinal side surface portion 42 which is a main longitudinal side surface portion of the shoulder block 26 is a boundary between the lateral groove 20B and the shoulder main groove 18B, and the length L0 of the lateral groove 20B is a distance between the boundary and the tire ground contact end E on a groove center line P2 of the lateral groove 20B.

The lengths (lengths along the groove center line P2) of respective the shallow groove portions 52, 54, and 56 may be set, for example, as follows. A length L1 of the first shallow groove portion 52 and a length L2 of the second shallow groove portion 54 are preferably 10 to 40% of the length L0 of the lateral groove 20B, and are more preferably 15 to 30% thereof. The length L3 of the third shallow groove portion 56 is preferably 5 to 20% of the length L0 of the lateral groove 20B, and is more preferably 5 to 15% thereof. In addition, the length L1 of the first shallow groove portion 52 is preferably equal to or greater than the length L3 of the third shallow groove portion 56 (that is, L1≧L3), and is more preferably greater than L3 (that is, L1>L3). The length L2 of the second shallow groove portion 54 is preferably greater than the length L3 of the third shallow groove portion 56 (that is, L2>L3). Here, as illustrated in FIG. 5, the lengths L1, L2, and L3 of respective the shallow groove portions 52, 54, and 56 are lengths of a substantially flat upper surface portion of the bridge excluding the inclined surfaces on both sides (however, irregularities due to the serrations which are described below are considered to be “flat”).

The groove bottoms (that is, the upper surfaces of the bridges) of the first shallow groove portion 52, the second shallow groove portion 54, and the third shallow groove portion 56 are respectively provided with serrations 62A, 62B, and 62C which are formed by providing a plurality of ridges 60 extending to be inclined with respect to the tire circumferential direction C side by side at equal intervals. The intervals (arrangement intervals of the ridges 60) G of the serrations 62A, 62B, and 62C are preferably 0.5 to 2.5 mm (see FIG. 5). In addition, depths (that is, heights of the ridges 60) D of the serrations 62A, 62B, and 62C are preferably 0.5 to 2.0 mm. In addition, an inclined angle of the ridge 60 with respect to the tire circumferential direction C is preferably 30° to 60° from the viewpoint of enhancing the effect of the serrations 62A, 62B, and 62C.

As illustrated in FIG. 4, in the serrations 62A, 62B, and 62C of the adjacent shallow groove portions 52, 54, and 56, the inclined angles of the ridges 60 are set to be in the opposite direction. That is, the ridges 60 configuring the serrations 62B of the second shallow groove portion 54 are inclined in the opposite direction to the ridges 60 respectively configuring the serrations 62A of the first shallow groove portion 52 and the serrations 62C of the third shallow groove portion 56 in the tire circumferential direction C.

As illustrated in FIGS. 2 to 4, a bridge 64 connecting the lateral side surface portions 30 and 30 facing each other is also provided in each lateral groove 20A between the adjacent center blocks 24 and 24 in the tire circumferential direction C. Therefore, a shallow groove portion 66 shallower than the main groove 18 in depth is formed in the lateral groove 20A. The shallow groove portion 66 in the center block row 22A is formed in one step and is formed in a range of equal to or greater than 50% including a center portion in the length direction of the lateral groove 20A. In addition, similar to the first to third shallow groove portions 52, 54, and 56, a groove bottom (that is, a bridge upper surface) of the shallow groove portion 66 is provided with serrations 68 formed by providing a plurality of ridges extending to be inclined with respect to the tire circumferential direction C side by side.

Moreover, in FIGS. 2 and 3, reference numeral 70 is a notch formed in a recessed cut at a side surface portion of each of the blocks 24 and 26 for increasing the number of the traction elements. The notch 70 is provided at each center portion in each of the first longitudinal side surface portion 32 of the center block 24, and the third longitudinal side surface portion 42 and the longitudinal side surface portion 38 of the shoulder block 26. In addition, reference numeral 72 is a reinforcing projection portion which is provided between the notches 70 and 70 facing each other with the main groove 18 sandwiched therebetween and connects both, and the reinforcing projection portion is formed to protrude from the groove bottom of the main groove 18. Reference numeral 74 is a protrusion which is provided on the groove bottom of the main groove 18 to prevent stone biting and a plurality of protrusions 74 are disposed at intervals in the length direction of the main groove 18. Reference numeral 76 is a cut, that is, a sipe provided in each of the blocks 24 and 26 for improving the traction property, and a plurality of sipes 76 are provided in each of the blocks 24 and 26.

According to the embodiment described above, it is possible to increase the rigidity of the blocks 24 and 26 and to suppress the movement of the blocks 24 and 26 by providing the shallow groove portions 52, 54, 56, and 66 in the lateral grooves 20A and 20B. Therefore, it is possible to suppress uneven wear. Particularly, although the shoulder block 26 is affected not only by a longitudinal force but also by a lateral force, it is possible to effectively enhance the rigidity and to improve the uneven wear resistance property by providing the first to third shallow groove portions 52, 54, and 56 having different depths as described above. Furthermore, since a groove volume can be secured while enhancing the rigidity by having multiple steps, it is possible to suppress deterioration in the earth discharging property and the traction property. In addition, even when worn, since the shallow groove portions 52, 54, and 56 are exposed in a stepwise manner, it is possible to suppress deterioration in the traction property also in this respect.

Here, the depth H1 of the first shallow groove portion 52 and the depth H3 of the third shallow groove portion 56 are preferably 40 to 70% of the depth of the shoulder main groove 18, are more preferably 50 to 65% thereof. If the depths H1 and H3 of the first and third shallow groove portions 52 and 56 are equal to or greater than 40% of the depth of the main groove, it is possible to sufficiently secure the groove volume and to suppress deterioration in the earth discharging property. In addition, if the depths thereof are equal to or less than 70%, sufficient rigidity of the shoulder block 26 is secured. Therefore, it is possible to enhance the uneven wear resistance property.

In addition, the depth H2 of the second shallow groove portion 54 is preferably 30 to 60% of the depth of the shoulder main groove 18B, is more preferably 40 to 55% thereof. If the depth H2 of the second shallow groove portion 54 is equal to or greater than 30% of the depth of the main groove, a sufficient groove volume can be secured. Therefore, it is possible to suppress deterioration in the earth discharging property. In addition, if the depth is equal to or less than 60%, a sufficient rigidity of the shoulder block 26 is secured. Therefore, it is possible to enhance the uneven wear resistance property.

According to the embodiment, it is possible to effectively suppress uneven wear due to the lateral force by providing the second shallow groove portion 54, which is offset toward the tire ground contact end E side, within the lateral groove 20B between the shoulder blocks 26 which are easily influenced by the lateral force and have severe uneven wear resistance property. Furthermore, since the groove volume is not greatly reduced, it is possible to secure the traction property and the earth discharging property.

According to the embodiment, it is possible to suppress extreme deterioration in the traction property by the serrations 62A, 62B, and 62C which are exposed as wear progresses by providing the serrations 62A, 62B, and 62C inclined with respect to the tire circumferential direction C in the groove bottom of each of the shallow groove portions 52, 54, and 56. In addition, it is possible to exhibit the traction effect in a stepwise manner by the serrations 62A, 62B, and 62C by exposing the serrations 62A, 62B, and 62C in a stepwise manner.

In addition, since the serrations 62A, 62B, and 62C of the adjacent shallow groove portions 52, 54, and 56 are formed to be inclined in the opposite direction, the visual effect is also excellent.

In the embodiment, the bridges 50 forming the first to third shallow groove portions 52, 54, and 56 are provided for all the lateral grooves 20B existing in the shoulder block row 22B, but may not be necessarily provided in all the lateral grooves 20B. In addition, in the shoulder land portions on the both end portions in the tire width direction, the configuration having the bridges 50 is adopted, but it may be adopted only in one of the shoulder land portions. In addition, the tread pattern is not limited to the embodiment described above. For example, in the embodiment, the number of the main grooves 18 is three, but the number of the main grooves is not particularly limited and, for example, may be four or five. The number of the main grooves is preferably three or four. In addition, although the main groove 18 is the zigzag groove, it may be a straight groove or a tread pattern combining the zigzag groove and the straight groove. Furthermore, as long as it has at least one shoulder block row, the other land portions may not be in the block row, that is, may be rib-like land portions.

The pneumatic tire according to the embodiment includes various vehicle tires such as a tire for a passenger car, a heavy duty tire of a truck, a bus, or a light truck (for example, an SUV vehicle or a pickup truck) or the like. In addition, applications such as a summer tire, a winter tire, and all-season tire are not particularly limited. It is preferable that the tire is the heavy duty tire.

Each dimension described above in the present specification is provided in a regular state with no load in which the pneumatic tire is mounted on a regular rim and is filled with air of a regular internal pressure. The regular rim is a “standard rim” in the JATMA standard, a “Design Rim” in the TRA standard, or a “Measuring Rim” in the ETRTO standard. The “regular internal pressure” is the “maximum air pressure” in the JATMA standard, the “maximum value” described in “TIRE LOAD LIMITS AT VARIOUS COLD INFLATION PRESSURES” in the TRA standard, or “INFLATION PRESSURE” in the ETRTO standard.

### EXAMPLES

In order to confirm the above effects, each heavy duty pneumatic tire (tire size: 11R22.5) of Examples 1 and 2, and Comparative Examples 1 and 2 was mounted on a rim of 22.5×7.50, filled with air of an internal pressure of 700 kPa, mounted on a vehicle with a constant loading capacity of 10 t, and evaluated for the earth discharging property, the traction property, and the uneven wear resistance property.

The tire of Example 2 includes features of the embodiment illustrated in FIGS. 1 to 7. In Example 2, the groove width of the main groove=11.5 mm, the depth of the main groove=16.5 mm, and for the first to third shallow groove portions 52, 54, and 56 (indicated as “three steps” in Table 1), H1=H3=9.9 mm, H2=7.9 mm, L1=8.5 mm, L2=8.0 mm, L3=4.5 mm, L0=35.2 mm, G=1.0 mm, D=0.6 mm, and the center position M1 of the second shallow groove portion was offset by 2.0 mm on the tire ground contact end E side with respect to the center position M0 of the lateral groove. The tire of Example 1 has the same configuration as that of the tire of Example 2 except that the center position M1 of the second shallow groove portion is made to coincide with the center position M0 of the lateral groove. The tire of Comparative Example 1 has the same configuration as that of Example 2 except that one step of a shallow groove portion (indicated as “one step” in Table 1) having a depth of 8.9 mm and a length of 21.0 mm is provided in the lateral groove 20B between the shoulder blocks 26 instead of providing the first to third shallow groove portions 52, 54, and 56. The tire of Comparative Example 2 has the same configuration as that of Example 2 except that a shallow groove portion is not provided in the lateral groove 20B between the shoulder blocks 26.

Each evaluation method is as follows.
The earth discharging property (mud performance): an arrival time when advanced 20 m from a stop state on a muddy road was measured, and an inverse number of the arrival time was indexed with the value of Comparative Example 1 taking as 100. The larger the index is, the shorter the arrival time is and the better the earth discharging property is.
The traction property: an arrival time when advanced 20 m from a stop state on a road surface having a water depth of 1.0 mm was measured, and an inverse number of the arrival time was indexed with the value of Comparative Example 1 taking as 100. The larger the index is, the shorter the arrival time is and the better the traction property is.
The uneven wear resistance property: an uneven wear state (heel and toe wear amount) after traveling 20,000 km was measured and an inverse number of the heel and toe wear amount was indexed with the value of Comparative Example 1 taking as 100. The larger the index is, the less uneven wear occurs and the more excellent the uneven wear resistance property is.

TABLE 1

| | Compar- | Compar- | | |
|---|---|---|---|---|
| | ative | ative | | |
| | Example 1 | Example 2 | Example 1 | Example 2 |
| Presence or absence | One step | Absence | Three steps | Three |
| of shallow groove | | | | steps |
| portion of shoulder | | | | |
| block row | | | | |
| Presence or absence | Presence | — | Presence | Presence |
| of serration of | | | | |
| shallow groove | | | | |
| portion | | | | |
| Relationship between | — | — | Coincidence | Offset |
| center position of | | | | toward |
| second shallow | | | | ground |
| groove portion and | | | | contact |
| center position of | | | | end |
| lateral groove | | | | |
| Earth discharging | 100 | 108 | 104 | 104 |
| property | | | | |
| Traction property | 100 | 107 | 105 | 105 |
| Uneven wear | 100 | 89 | 102 | 104 |
| resistance property | | | | |

The results are as shown in Table 1, in Comparative Example 1, by providing the shallow groove portion, the uneven wear resistance property was improved, but the earth discharging property and the traction property are greatly impaired compared to Comparative Example 2. On the other hand, in Examples 1 and 2 in which three steps of the shallow groove portions are provided in the lateral groove of the shoulder block row, the uneven wear resistance property was greatly improved while suppressing deterioration in the earth discharging property and the traction property compared to Comparative Example 2. Particularly, in Example 2, the uneven wear resistance property can be further improved without impairing the earth discharging property and the traction property by offsetting the second shallow groove portion toward the tire ground contact end side compared to Example 1.

While several embodiments are described above, these embodiments are presented by way of example and are not intended to limit the scope of the invention. These novel embodiments can be implemented in various other forms, and various omissions, substitutions, and changes can be made without departing from the spirit of the invention.

What is claimed is:

1. A pneumatic tire comprising:
a tread portion, wherein a shoulder block row in which a plurality of shoulder blocks partitioned by lateral grooves between a main groove extending in a tire circumferential direction and a tire ground contact end are arranged in the tire circumferential direction, are provided at an end portion of the tread portion in a tire width direction,
wherein the lateral groove between adjacent shoulder blocks in the tire circumferential direction includes a first shallow groove portion that is positioned on a side close to the main groove and has a depth shallower than that of the main groove, a third shallow groove portion that is positioned on a side close to the tire ground contact end and has a depth shallower than that of the main groove, and a second shallow groove portion that is positioned between the first shallow groove portion and the third shallow groove portion, and has a depth shallower than those of the first shallow groove portion and the third shallow groove portion.

2. The pneumatic tire according to claim 1,
wherein a center position of the second shallow groove portion in the tire width direction is positioned closer to a tire ground contact end side than a center position of the lateral groove in the tire width direction.

3. The pneumatic tire according to claim 1,
wherein the depth of the first shallow groove portion and the depth of the third shallow groove portion are respectively 40 to 70% of the depth of the main groove, and the depth of the second shallow groove portion is 30 to 60% of the depth of the main groove.

4. The pneumatic tire according to claim 1,
wherein each groove bottom of the first shallow groove portion, the second shallow groove portion, and the third shallow groove portion is provided with serrations formed by disposing a plurality of ridges extending obliquely side by side with respect to the tire circumferential direction.

5. The pneumatic tire according to claim 4,
wherein the ridges configuring the serrations of the second shallow groove portion are inclined in the opposite direction to the ridges configuring the serrations of the first shallow groove portion and the third shallow groove portion.

6. The pneumatic tire according to claim 1,
wherein a length of the first shallow groove portion is 10 to 40% of a length of the lateral groove, a length of the second shallow groove portion is 10 to 40% of the length of the lateral groove, a length of the third shallow groove portion is 5 to 20% of the length of the lateral groove, the length of the first shallow groove portion is equal to or greater than the length of the third shallow groove portion, and the length of the second shallow groove portion is greater than the length of the third shallow groove portion.
